(19) United States
(12) Patent Application Publication
(10) Pub. No.: US 2006/0118530 A1
(43) Pub. Date: Jun. 8, 2006

(54) Method and apparatus for cutting a chip by laser

(76) Inventor: Chih-Ming Hsu, Lujhu Township (TW)

Correspondence Address: PRO-TECTOR INTERNATIONAL SERVICES, 20775 NORADA CT., SARATOGA, CA, 95070, US

(21) Appl. No.: 11/007,336

(22) Filed: Dec. 7, 2004

(51) Int. Cl. B23K 26/38

(52) U.S. Cl. 219/121.67

(57) ABSTRACT

A laser cutting apparatus for cutting a chip includes a working table with a through-hole, a laser device mounted above the working table, the laser device generating a laser beam for cutting the chip, and an electronic microcamera mounted below the working table for observing the chip on the working table via the through-hole of the working table. A chip is mounted on the working table and located on top of the through-hole of the working table. The laser beam cuts a light-tight layer and an epilayer of the chip from top of the chip, obtaining individual crystallites without damaging the performance of the crystallites. The ratio of qualified crystallites is increased, allowing mass production of the crystallites.

### BACKGROUND OF THE INVENTION

1. Field of the Invention

The present invention relates to a laser cutting method. In particular, the present invention relates to a method for cutting a chip by laser. The present invention also relates to a laser cutting apparatus for cutting a chip.

2. Description of the Related Art

In current procedures for manufacturing light-emitting diodes (LEDs) and memories, numerous densely arrayed crystallite units are produced on a chip, and a laser cutting apparatus is used to cut the crystalline units into numerous crystallites.

A typical chip includes an electrode layer, a gem layer, and an epilayer (or epitaxy layer) between the electrode layer and the gem layer. In a laser cutting procedure, the chip is placed on a working table of a laser cutting apparatus, with the electrode layer facing upward or downward. An electronic microcamera is mounted above the working table for observing the electrode layer or the gem layer, showing the arrangement and location of each crystallite unit in the epilayer of the chip and allowing the operator to adjust the position of the working table and the chip. The chip is cut by a laser beam from top to obtain individual crystallites.

The electrode layer and the gem layer of the chip are light-transmissible layers, which is suitable to observation and laser cutting from top. However, a metal layer not transmissible to light is added on an outer face of the gem layer for a chip for high-performance, high-brightness LEDs or high-frequency memories, forming a light-tight layer. Thus, the chip must be placed on the working table with the electrode layer facing upward to allow observation by the electronic microcamera from top, with the laser beam cutting the light-transmissible electrode layer, the epilayer, and the light-tight layer (including the metal layer and the gem layer) from top. However, the energy intensity required for cutting is too strong and thus causes damage to the chip performance, resulting in a poor ratio of qualified crystallites as well as a low production rate.

### SUMMARY OF THE INVENTION

An objective of the present invention is to provide a method for cutting a chip by laser that has a higher production rate.

Another objective of the present invention is to provide a laser cutting apparatus for cutting a chip at a higher production rate.

In accordance with an aspect of the invention, a method for cutting a chip comprises:

placing a chip on a working table, with the chip being located on top of a through-hole of the working table, with a light-tight layer of the chip facing upward, and with a light-transmissible layer of the chip facing downward;

observing crystallite units in an epilayer of the chip via the through-hole with an electronic microcamera mounted below the working table; and

cutting the light-tight layer and the epilayer of the chip from top of the working table with a laser beam to obtain individual crystallites.

The method may further comprise a step of filtering the laser beam by a laser filtering lens on the electronic microcamera.

In accordance with another aspect of the invention, a laser cutting apparatus for cutting a chip comprises a working table including a through-hole, a laser device mounted above the working table, the laser device generating a laser beam for cutting the chip, and an electronic microcamera mounted below the working table for observing the chip on the working table via the through-hole of the working table. A chip is mounted on the working table and located on top of the through-hole of the working table.

The laser cutting apparatus may further comprise another electronic microcamera mounted on above the working table for observing the chip. The electronic microcamera above the working table may comprise a laser filtering lens. The laser device comprises a laser generator for generating the laser beam. Further, the laser device comprises at least one reflecting lens and a laser beam-concentrating lens for guiding the laser beam to the chip.

The laser beam cuts a light-tight layer and an epilayer of the chip from top of the chip, obtaining individual crystallites without damaging the performance of the crystallites. The ratio of qualified crystallites is increased, allowing mass production of the crystallites.

Other objectives, advantages, and novel features of the invention will become more apparent from the following detailed description when taken in conjunction with the accompanying drawings.

### BRIEF DESCRIPTION OF THE DRAWINGS

FIG. 1 is a front elevational view, partly sectioned, of a laser cutting apparatus in accordance with the present invention.

FIG. 2 is a top view of the laser cutting apparatus in FIG. 1.

FIG. 3 is a top view of the laser cutting apparatus in FIG. 1, wherein a laser device is removed to show a single-direction reflective lens.

FIG. 4 is a sectional view of a chip to be cut by the laser cutting apparatus in accordance with the present invention.

### DETAILED DESCRIPTION OF THE PREFERRED EMBODIMENT

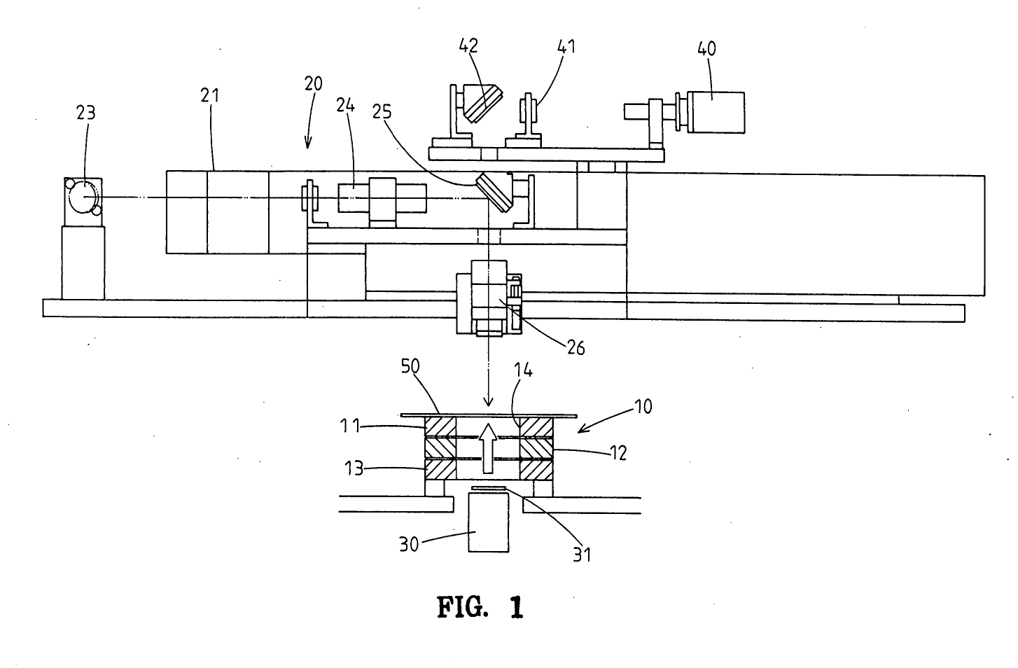

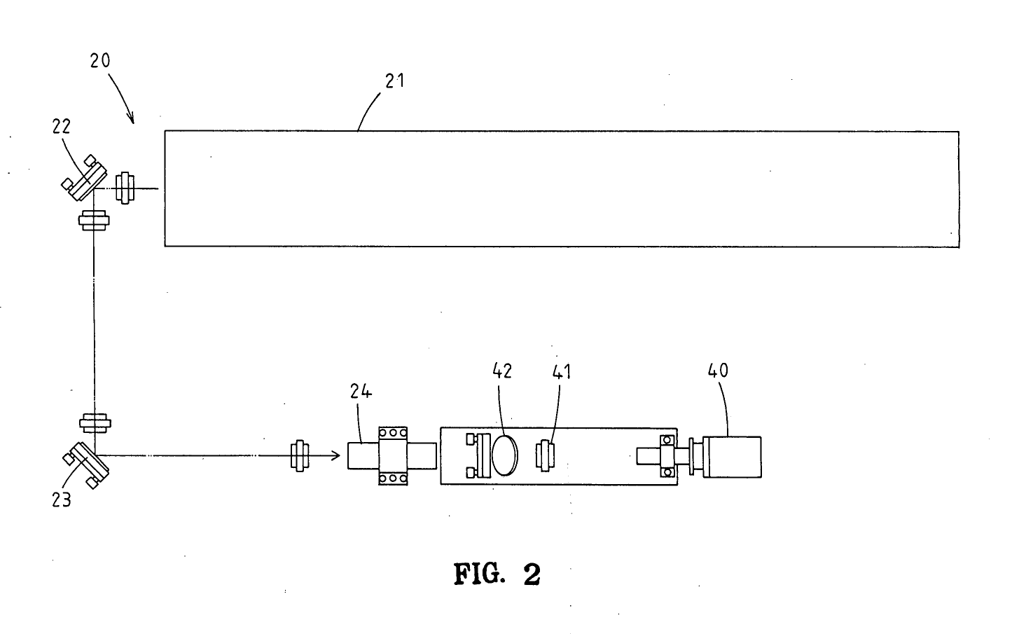

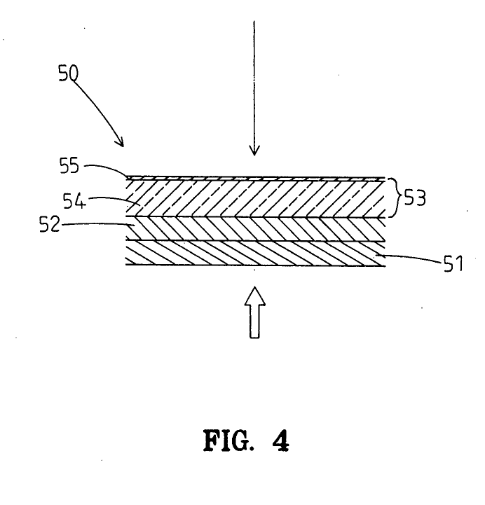

Referring to FIGS. 1 and 2, a laser cutting apparatus in accordance with the present invention comprises a working table 10, a laser device 20 mounted above the working table 10, and an electronic microcamera 30 mounted below the working table 10. A chip 50 is mounted on the working table 10 and includes a light-transmissible layer (or electrode layer) 51, an epilayer 52 on an upper face of the light-transmissible layer 51, and a light-tight layer 53 on an upper face of the epilayer 52. The light-tight layer 53 includes a gem layer 54 on an upper face of the epilayer 52 and a metal layer 55 on an upper face of the gem layer 54, as shown in FIG. 4. The metal layer 55 is not transmissible to light or has a fogged face.

The working table 10 includes a longitudinally movable table 13, a transversely movable table 12 on top of the longitudinally movable table 13, and a turntable 11 on top of the transversely movable table 12. Each table 11, 12, 13 has a through-hole 14. The through-holes 14 can be adjusted to align with one another by adjusting the positions of the tables 11, 12 and 13. The chip 50 is placed on top of the turntable 11. The electronic microcamera 30 is mounted below the aligned through-holes 14 of the tables 11, 12, and 13 to observe arrangement and location of each crystallite unit in the epilayer 52 of the chip 50.

Still referring to FIGS. 1 and 2, the laser device 20 includes a laser generator 21 that emits a laser beam passing through reflecting lenses 22 and 23, an optical amplifier 23, and a single-direction reflecting lens 25. The laser beam is reflected downward by the single-direction reflecting lens 25 and passes through a light beam-concentrating lens 26 to the chip 50. The single-direction reflecting lens 25 reflects the laser beam downward. The light beam-concentrating lens 26 increases the laser intensity to precisely cut the chip 50.

The electronic microcamera 30 mounted below the working table 10 is coaxially aligned with the light beam-concentrating lens 26 for observing the chip 50. The electronic microcamera 30 includes a laser filtering lens 31 to filter the laser beam, preventing the electronic microcamera 30 from being damaged by the laser beam.

In use, as shown in FIGS. 1 and 4, the chip 50 (a high-performance one) is placed on the working table 10 and located above the aligned through-holes 14 with the light-light layer 53 facing upward. The arrangement and location of each crystallite unit in the epilayer 52 of the chip 50 can be clearly observed by the electronic microcamera 30 via the through-holes 14. The positions of the working table 10 and the chip 50 can be adjusted by the operator. The laser beam cuts the light-tight layer 53 and the epilayer 52 of the chip 50 from top of the chip 50, obtaining individual crystallites without damaging the performance of the crystallites. The ratio of qualified crystallites is increased, allowing mass production of the crystallites.

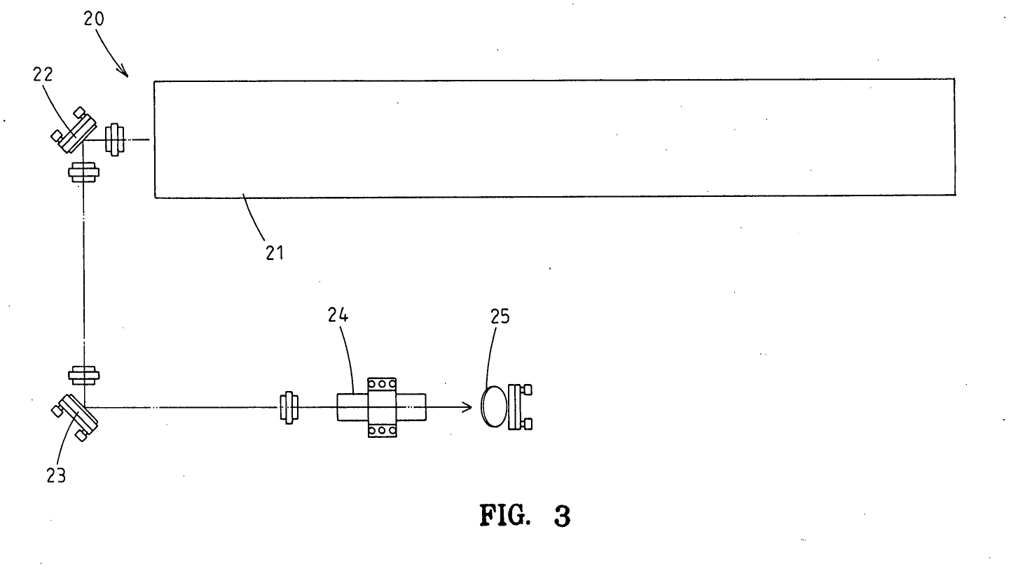

In this embodiment, an additional electronic microcamera 40 is mounted above the working table 10, as shown in FIGS. 1 and 3. The chip 50 on the working table 10 below the electronic microcamera 40 can be observed via an amplifying lens 41, a reflecting lens 42, the single-direction reflecting lens 25, and the light beam-concentrating lens 26. In this case, the single-direction reflecting lens 25 allows direct passage of light.

Although a specific embodiment has been illustrated and described, numerous modifications and variations are still possible without departing from the essence of the invention. The scope of the invention is limited by the accompanying claims.

What is claimed is:

1. A method for cutting a chip, comprising:
placing a chip on a working table, with the chip being located on top of a through-hole of the working table, with a light-tight layer of the chip facing upward, and with a light-transmissible layer of the chip facing downward;
observing crystallite units in an epilayer of the chip via the through-hole with an electronic microcamera mounted below the working table; and
cutting the light-tight layer and the epilayer of the chip from top of the working table with a laser beam to obtain individual crystallites.

2. The method as claimed in claim 1 further comprising a step of filtering the laser beam by a laser filtering lens on the electronic microcamera.

3. A laser cutting apparatus for cutting a chip, comprising:
a working table including a through-hole, a chip being adapted to be being mounted on the working table and located on top of the through-hole of the working table;
a laser device mounted above the working table, the laser device generating a laser beam for cutting the chip; and
an electronic microcamera mounted below the working table for observing the chip on the working table via the through-hole of the working table.

4. The laser cutting apparatus as claimed in claim 3 wherein the laser cutting apparatus further comprises another electronic microcamera mounted on above the working table for observing the chip.

5. The laser cutting apparatus as claimed in claim 3 wherein the electronic microcamera above the working table comprises a laser filtering lens.

6. The laser cutting apparatus as claimed in claim 5 wherein the laser cutting apparatus further comprises another electronic microcamera mounted on top of the working table for observing the chip.

7. The laser cutting apparatus as claimed in claim 6 wherein the electronic microcamera above the working table comprises a laser filtering lens.

8. The laser cutting apparatus as claimed in claim 3 wherein the laser device comprises a laser generator for generating the laser beam, the laser device further comprising at least one reflecting lens and a laser beam-concentrating lens for guiding the laser beam to the chip.
